(19) United States
(12) Patent Application Publication
(10) Pub. No.: US 2026/0329397 A1
(43) Pub. Date: Oct. 22, 2026

(54) Sensing System for Determining Position of Input Object on Touch Screen

(71) Applicant: HIMAX TECHNOLOGIES LIMITED, Tainan City (TW)

(72) Inventors: Yi-Chen Tzung, Tainan City (TW); Yaw-Guang Chang, Tainan City (TW); Hui-Min Wang, Tainan City (TW)

(73) Assignee: HIMAX TECHNOLOGIES LIMITED, Tainan City (TW)

(21) Appl. No.: 19/224,878

(22) Filed: Jun. 1, 2025

Related U.S. Application Data
(60) Provisional application No. 63/782,018, filed on Apr. 2, 2025.

(51) Int. Cl. G06F 3/041

(52) U.S. Cl. CPC G06F 3/04166

(57) ABSTRACT

A sensing system for determining a position of an input object on a touch screen is proposed. The system includes a plurality of touch line receivers, a plurality of multiplexers (MUXs), and a plurality of analog-to-digital converters (ADCs). The plurality of touch line receivers is configured to receive a touch signal corresponding to the input object. Each MUX is coupled to N touch line receivers based on a predetermined mapping scheme, and the N touch line receivers are partitioned into a first receiver group and a second receiver group. Each ADC is coupled to a corresponding MUX and configured to convert the touch signal into a digital signal. The first receiver group is used for receiving the touch signal during a first time cycle, the second receiver group is used for receiving the touch signal during a second time cycle.

### CROSS REFERENCE TO RELATED APPLICATIONS

This application claims the benefit of U.S. Provisional Application No. 63/782,018, filed on April 2, 2025. The content of the application is incorporated herein by reference.

### BACKGROUND OF THE INVENTION

### 1. Field of the Invention

The present invention relates to a sensing system, in particularly, to a sensing system for determining a position of an input object on a touch screen.

### 2. Description of the Prior Art

In a touch screen application, a pen or a finger touches the touch screen to send a touch signal, and a plurality of analog-to-digital converters (ADCs) convert the touch signal into a plurality of digital signals. In prior art, conventional sensing techniques employ Analog-to-Digital Converters (ADCs) sequentially. For example, X-axis scanning for utilizing vertical connections is performed during a first time cycle, followed by Y-axis scanning, utilizing horizontal connections during a second time cycle. However, in the horizontal connections for Y-axis scanning, they must traverse multiple VCOM (Common Voltage) plates. As a result, it may extend signal trace lengths within the integrated circuit (IC), consequently increasing signal impedance and detrimentally affecting the ability to accurately sample energy from sources like an active pen.

### SUMMARY OF THE INVENTION

An embodiment provides a sensing system for determining a position of an input object on a touch screen. The system includes a plurality of touch line receivers, a plurality of multiplexers (MUXs), and a plurality of analog-to-digital converters (ADCs). The plurality of touch line receivers is configured to receive a touch signal corresponding to the input object. Each MUX of the plurality of MUXs is coupled to N touch line receivers based on a predetermined mapping scheme, N is an integer greater than one, and the N touch line receivers are partitioned into a first receiver group and a second receiver group. Each ADC of the plurality of ADCs is coupled to a corresponding MUX and configured to convert the touch signal into a digital signal. The first receiver group is used for receiving the touch signal during a first time cycle, the second receiver group is used for receiving the touch signal during a second time cycle, and the position of the input object on the touch screen is determined based on at least the digital signal across the first time cycle and the second time cycle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a sensing system according to an embodiment of the present invention.

FIG. 2 is a schematic diagram of a predetermined mapping scheme according to another embodiment of the present invention.

FIG. 3 is a schematic diagram of a sensing algorithm according to another embodiment of the present invention.

FIG. 4 is a schematic diagram of a sensing system according to another embodiment of the present invention.

FIG. 5 is a schematic diagram of a predetermined mapping scheme according to another embodiment of the present invention.

FIG. 6 is a schematic diagram of a sensing algorithm according to another embodiment of the present invention.

### DETAILED DESCRIPTION

Conventional method for signal sensing using Analog-to-Digital Converters (ADCs) involves utilizing VCOM (Common Voltage) plates applied in a receiver (say, touch line receivers) matrix, such as a 4×4 array. Specifically, the conventional method operates in distinct time slots to determine a touch position. For example, sensing along a first axis (e.g., the X-axis, corresponding to columns of the receiver matrix) is performed during a first time slot, where touch signals from VCOM plates aligned along this axis are captured by four “row” ADCs. Subsequently, during a second time slot, sensing along a second, orthogonal axis (e.g., the Y-axis, corresponding to rows of the receiver matrix) is performed, with signals from VCOM plates aligned along the second axis captured by another four “column” ADCs. Therefore, a final position of a touch object is then determined by interpolating the location based on the signal strengths detected during the X-axis and Y-axis sensing phases within the respective time slots.

However, conventional signal sensing systems may suffer from insufficient accuracy or resolution, exhibit slow response times limiting their effectiveness or applicability in dynamic environments, and involve high manufacturing costs and system complexity since the extended signal trace lengths within the integrated circuit (IC) may be introduced. To address such issues, the sensing system in the embodiment is disclosed to overcome one or more of the shortcomings inherent in conventional signal sensing technologies. The purpose of the embodiment is to provide an improved sensing solution that offers enhanced capabilities.

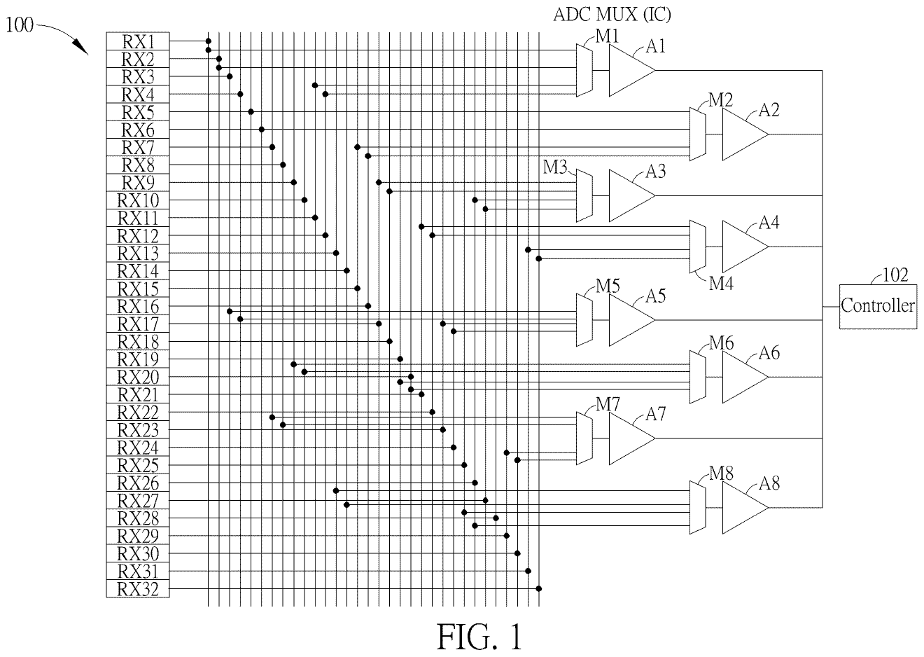

FIG. 1 is a schematic diagram of a sensing system 100 according to an embodiment of the present invention. The sensing system 100 is configured to determine a position of an input object on a touch screen. In the embodiment, the sensing system 100 includes a plurality of touch line receivers RX1 to RX32, a plurality of multiplexers (MUXs) M1 to M8, a plurality of ADCs A1 to A8, and a controller 102. The plurality of touch line receivers RX1 to RX32 is configured to receive a touch signal corresponding to the input object. In an embodiment, the input object can be a pen (stylus) or a finger. In the sensing system 100, when the input object interacts with the touch screen, it generates a touch signal corresponding to the input event. Due to the physical nature of the interaction (e.g., contact area, capacitive coupling), the resulting electrical effect, characterized by a voltage distribution or energy distribution associated with the touch signal, is not confined to a single, discrete point. Instead, the voltage distribution spatially spreads across the surface of the touch screen. Therefore, the spatial distribution results in the influence of the touch signal extending over an area that spans at least one touch-sensing unit, wherein the touch-sensing unit is monitored or detected by a corresponding touch line receiver.

In the sensing system 100, each MUX of the plurality of MUXs M1 to M8 is coupled to N touch line receivers based on a predetermined mapping scheme. N is an integer greater than one. In an embodiment, N is 4. The N touch line receivers are partitioned into a first receiver group and a second receiver group. For example, four touch line receivers RX1, RX11, RX2, and RX12 coupled to the MUX M1 are partitioned into a first receiver group including touch line receivers RX1 and RX11, and a second receiver group including touch line receivers RX2 and RX12. Each ADC of the plurality of ADCs A1 to A8 is coupled to a corresponding MUX and configured to convert the touch signal into a digital signal. The first receiver group is used for receiving the touch signal during a first time cycle. The second receiver group is used for receiving the touch signal during a second time cycle. The position of the input object on the touch screen is determined based on the digital signals converted by the ADCs A1 to A8 in the first time cycle and the second time cycle.

In an embodiment, generally, a total number of the plurality of touch line receivers is M times a total number of the plurality of ADCs. M is an integer greater than 1. In an embodiment, given touch line receivers RX1 to RX32 and ADCs A1 to A8, M is 4. Furthermore, the controller 102 is coupled to the plurality of ADCS A1 to A8 and configured to identify a spatial pattern of an energy distribution associated with the input object by processing digital signals from the ADCs A1 to A8. The controller 102 compares the spatial pattern with a predefined effective characteristic shape. The effective characteristic shape exhibits a predetermined concentration of energy proximate to the position of the input object. The controller 102 can include a processing logic circuit implemented as, but not limited to, a microprocessor (CPU), a microcontroller unit (MCU), a Digital Signal Processor (DSP), an Application-Specific Integrated Circuit (ASIC), or a Field-Programmable Gate Array (FPGA). Furthermore, the controller 102 can be realized as a standalone component or integrated within a larger System-on-a-Chip (SoC) that includes other functionalities of the sensing system 100. The layout structure of the sensing system 100 in FIG. 1 is illustrated below.

In an embodiment, ADC A1 is coupled to MUX M1, and MUX M1 is coupled to touch line receivers RX1, RX2, RX11, and RX12. ADC A2 is coupled to MUX M2, and MUX M2 is coupled to touch line receivers RX5, RX6, RX15, and RX16. ADC A3 is coupled to MUX M3, and MUX M3 is coupled to touch line receivers RX17, RX18, RX27, and RX28. ADC A4 is coupled to MUX M4, and MUX M4 is coupled to touch line receivers RX21, RX22, RX31, and RX32. ADC A5 is coupled to MUX M5, and MUX M5 is coupled to touch line receivers RX3, RX4, RX23, and RX24. ADC A6 is coupled to MUX M6, and MUX M6 is coupled to touch line receivers RX7, RX8, RX19, and RX20. ADC A7 is coupled to MUX M7, and MUX M7 is coupled to touch line receivers RX9, RX10, RX29, and RX30. ADC A8 is coupled to MUX M8, and MUX M8 is coupled to touch line receivers RX13, RX14, RX25, and RX26.

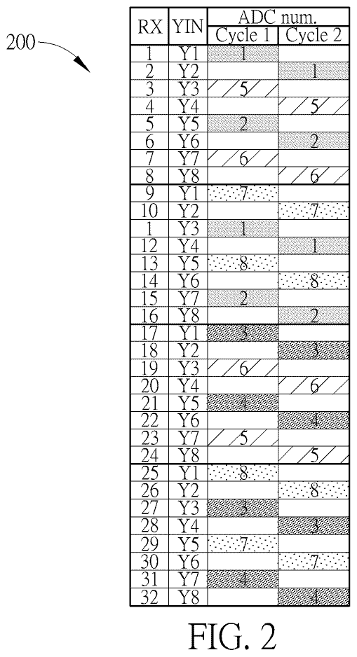

FIG. 2 is a schematic diagram of a predetermined mapping scheme 200 according to another embodiment of the present invention. The predetermined mapping scheme 200 includes a cyclic mapping of the plurality of touch line receivers RX1 to RX32 to the plurality of ADCs A1 to A8 via the plurality of MUXs M1 to M8. In an embodiment, ADCs A1 to A8 are coupled to MUXs M1 to M8, respectively. In the first time cycle, the first receiver group in each MUX is enabled. For example, MUX M1 switches to touch line receivers RX1 and RX11, MUX M2 switches to touch line receivers RX5 and RX15, MUX M3 switches to touch line receivers RX17 and RX27, MUX M4 switches to touch line receivers RX21 and RX31, MUX M5 switches to touch line receivers RX3 and RX23, MUX M6 switches to touch line receivers RX7 and RX19, MUX M7 switches to touch line receivers RX9 and RX29, and MUX M8 switches to touch line receivers RX13 and RX25. In the second time cycle, each MUX can be used for switching from the first receiver group to the second receiver group. For example, MUX M1 switches to touch line receivers RX2 and RX12, MUX M2 switches to touch line receivers RX6 and RX16, MUX M3 switches to touch line receivers RX18 and RX28, MUX M4 switches to touch line receivers RX22 and RX32, MUX M5 switches to touch line receivers RX4 and RX24, MUX M6 switches to touch line receivers RX8 and RX20, MUX M7 switches to touch line receivers RX10 and RX30, and MUX M8 switches to touch line receivers RX14 and RX26. In an embodiment, the first receiver group for the first time cycle and the second receiver group for the second time cycle are mutually exclusive.

In other words, in the sensing system 100, the division of the plurality of touch line receivers (RX1 to RX32) into at least a first receiver group and a second receiver group serves the purpose of time-division. The partitioning is implemented to facilitate the operation of these receiver groups in a time-division manner. That is, the sensing system 100 is configured to activate or enable the first receiver group for touch signal reception during the first time cycle, and subsequently activate or enable the second receiver group for touch signal reception during the second time cycle.

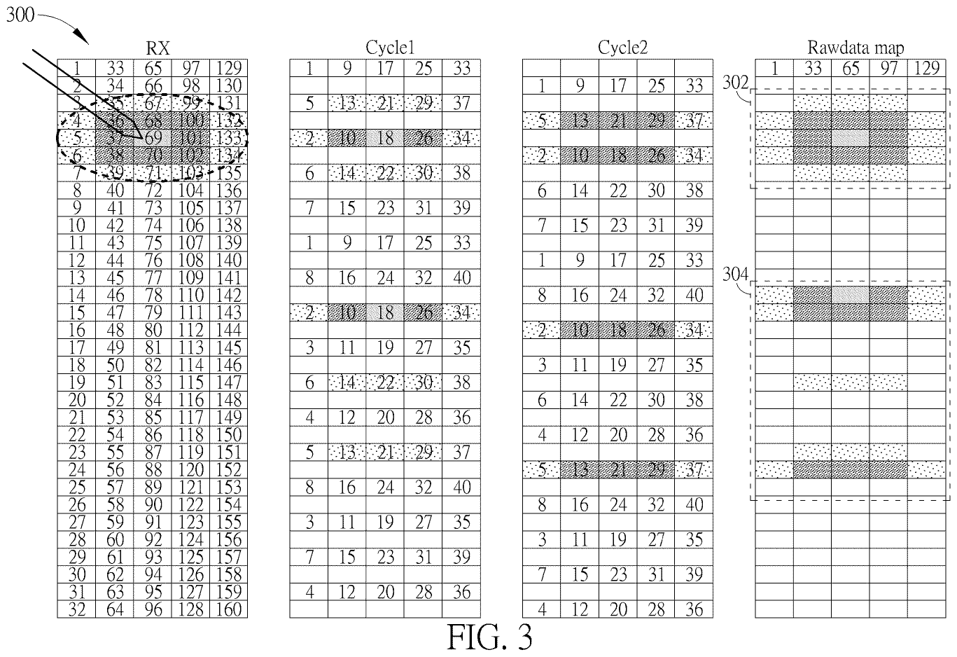

FIG. 3 is a schematic diagram of a sensing algorithm 300 according to another embodiment of the present invention. The sensing system in FIG. 3 includes 160 touch line receivers RX1 to RX160, 40 ADCs A1 to A40, 40 MUXs M1 to M40, and a controller coupled to the MUXs M1 to M40. In operation, when an input object makes contact with the touch screen proximate to a touch line receiver RX69, the touch line receiver RX69 detects a first touch signal. Concurrently, touch line receivers immediately surrounding the contact point, namely RX36, RX37, RX38, RX68, RX70, RX100, RX101, and RX102, detect second touch signals. Furthermore, touch line receivers located near the contact area, specifically touch line receivers RX4, RX5, RX6, RX35, RX39, RX67, RX71, RX99, RX103, RX132, RX133, and RX134, detect third touch signals. The signal strength hierarchy is such that the first touch signal possesses a greater magnitude than the second touch signals, and the second touch signals, in turn, possess a greater magnitude than the third touch signals.

This is due to the physical characteristics of the touch event (e.g., a finger or a stylus contacting the screen). When the input object contacts the touch screen, the resulting electrical effect (such as the voltage or energy distribution generated by capacitive coupling) is not confined to a single point. Instead, the electrical effect spreads spatially across the surface of the touch screen. Therefore, the highest signal strength will be at the touch line receiver closest to the actual contact point (in the embodiment, the touch line receiver RX69, receiving the first touch signal). As the distance from the contact point increases, the signal's influence gradually weakens, so the second touch signals received by the touch line receivers immediately surrounding the contact point (RX36, RX37, RX38, etc.) will be weaker, and the third touch signals received by the outer receivers (RX4, RX5, RX6, etc.) will have even weaker strength.

In an embodiment, the first touch signal is greater than a first threshold, the second touch signals are greater than a second threshold, and the third touch signals are greater than a third threshold.

In the first time cycle, the ADC A18 converts the first touch signal into a first digital signal, the ADCs A10 and A26 convert the second touch signals into the second digital signals, and the ADCs A2, A13, A14, A21, A22, A29, A30, and A34 convert the third touch signals into the third digital signals. In the second time cycle, the ADCs A13, A10, A21, A18, A29, and A26 convert the second touch signals into the second digital signals, and the ADCs A5, A2, A37, and A34 convert the third touch signals into the third digital signals. In an embodiment, the first digital signal is converted using the ADC A18, but ADC A18 can detect the signal from the touch line receiver RX69 or the touch line receiver RX79. This detection ambiguity arises because, as previously mentioned, each ADC is coupled to a corresponding MUX. The MUX sequentially enables different receiver groups during distinct time cycles. However, the touch line receivers within any single receiver group are active concurrently during that group's designated time cycle. As a result, the controller 102 cannot spatially distinguish between the individual touch line receivers belonging to the same active group based solely on the digital signal from that single time cycle. For example, after the controller 102 receives the digital signal from the first time cycle via a particular ADC (e.g., ADC18), the digital signal could correspond to input detected at either touch line receiver RX69 or touch line receiver RX79. Therefore, the controller 102 needs to combine the energy distribution information gathered across both the first time cycle and the second time cycle to determine the actual position of the touch event accurately.

Furthermore, the controller 102 is configured to analyze the processed digital signals representing the touch energy detected across the receiver array. Specifically, the controller 102 identifies a spatial pattern corresponding to the energy distribution associated with the input object's interaction with the touch screen. The determined spatial pattern is then compared by the controller 102 with a predefined effective characteristic shape. The predefined effective characteristic shape is stored or accessible by the controller 102 and represents a valid touch signature, defined by exhibiting a predetermined concentration of energy that is expected to be proximate to the actual position of the input object on the touch screen.

In the embodiment in FIG. 3, the position of the input object cannot be directly determined by considering only the first touch signal at the touch line receiver RX69 or the touch line receiver RX79. By comparing the characteristic shape combined by the first digital signal, the second digital signals, and the third digital signals, an effective characteristic shape 302 can be generated corresponding to the touch line receiver RX69. An invalid characteristic shape 304 can be generated corresponding to the touch line receiver RX79. Since the energy distribution within the invalid characteristic shape 304 is dispersed, the invalid characteristic shape 304 will be eliminated or discarded. Therefore, the effective characteristic shape 302 shows the correct position of the input object (stylus or finger) by comparing to the invalid characteristic shape 304.

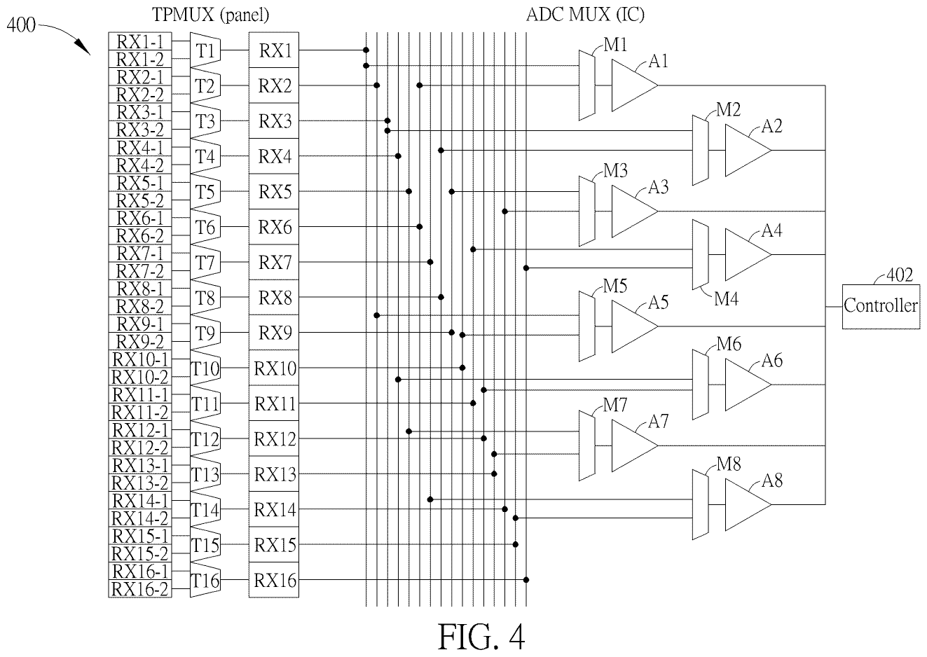

FIG. 4 is a schematic diagram of a sensing system 400 according to another embodiment of the present invention. The sensing system 400 is configured to determine a position of an input object on a touch screen. The sensing system 400 includes a plurality of touch line receivers RX1-1 to RX16-2, a plurality of multiplexers (MUXs) M1 to M8, a plurality of ADCs A1 to A8, a plurality of touch penal MUXs (TPMUXs) T1 to T16, and a controller 402. The plurality of touch line receivers RX1-1 to RX16-2 are configured to receive a touch signal corresponding to the input object. In an embodiment, the input object is a stylus or a finger. The TPMUXs T1 to T16 are integrated with the touch screen panel, and each TPMUX is coupled to K touch line receivers. K is a positive integer greater than one. In an embodiment, K is 2. For example, the TPMUX T1 is coupled to K=2 line receivers RX1-1 and RX1-2. The K touch line receivers are used for receiving K touch signals at different time slots. The K touch signals are sequentially received by a corresponding TPMUX. Each TPMUX is configured to select a touch signal from the K touch signals so as to reduce integrated circuit (IC) pins of the plurality of touch line receivers RX1-1 to RX16-2. The K touch line receivers are partitioned into a first receiver group and a second receiver group. Each MUX of the plurality of MUXs M1 to M8 is coupled to N touch line receivers based on a predetermined mapping scheme. In an embodiment, N is an integer greater than one. In an embodiment, N is 2. For example, the MUX M1 is coupled to two TPMUXs T1 and T6 for receiving two touch signals from touch line receivers {RX1-1 or RX1-2} and {RX6-1 or RX6-2}. Each ADC of the plurality of ADCs A1 to A8 is coupled to a corresponding MUX and configured to convert the touch signal into a digital signal. The first receiver group is used for receiving the touch signal during a first time cycle. The second receiver group is used for receiving the touch signal during a second time cycle, and the position of the input object on the touch screen is determined based on the digital signals converted by the ADCs A1 to A8 in the first time cycle and the second time cycle.

In an embodiment, a total number of the plurality of touch line receivers is M times a total number of the plurality of ADCs. M is an integer greater than 1. In an embodiment, given touch line receivers RX1-1 to RX 16-2 and ADCs A1 to A8, M is 4. Each MUX corresponding to each ADC connects to 2TPMUXs, and each TPMUX is coupled to 2 touch line receivers in FIG. 4. The controller 402 is coupled to the ADCs A1 to A8 and configured to identify a spatial pattern of an energy distribution associated with the input object by processing digital signals from the ADCs A1 to A8. The controller 402 compares the spatial pattern with a predefined effective characteristic shape, and the effective characteristic shape exhibits a predetermined concentration of energy proximate to the position of the input object.

Comparing the sensing system 400 depicted in FIG. 4 with the sensing system 100 depicted in FIG. 1, the sensing system 100 utilizes MUXs. Each MUX is coupled to a corresponding ADC for managing groups of touch line receivers. Such configuration enables time-division processing, allowing signals from different groups of touch line receivers to be sequentially acquired by the ADC. In contrast, within the sensing system 400, the time-division multiplexing mechanism is implemented, at least in part, by the touch panel multiplexers (TPMUXs) integrated with the touch screen panel itself. The TPMUXs perform a preliminary selection or grouping of the touch line receivers. Specifically, each TPMUX selects the touch signal from one line receiver within a group at a specific time slot for subsequent processing. By implementing the time-division selection stage directly on the panel using TPMUXs, the number of required IC pins for interfacing with the touch line receivers can be reduced, which also leads to decreased routing complexity.

In FIG. 4, in an embodiment, ADC A1 is coupled to MUX M1, and MUX M1 is coupled to touch line receivers RX1 and RX6. ADC A2 is coupled to MUX M2, and MUX M2 is coupled to touch line receivers RX3 and RX8. ADC A3 is coupled to MUX M3, and MUX M3 is coupled to touch line receivers RX9 and RX14. ADC A4 is coupled to MUX M4, and MUX M4 is coupled to touch line receivers RX11 and RX16. ADC A5 is coupled to MUX M5, and MUX M5 is coupled to touch line receivers RX2 and RX8. ADC A6 is coupled to MUX M6, and MUX M6 is coupled to touch line receivers RX4 and RX12. ADC A7 is coupled to MUX M7, and MUX M7 is coupled to touch line receivers RX5 and RX13. ADC A8 is coupled to MUX M8, and MUX M8 is coupled to touch line receivers RX7 and RX15. Touch line receivers RX1-RX16 are coupled to TPMUXs T1 to T16, respectively, and TPMUXs T1 to T16 are coupled to touch line receivers RX1-1 and RX1-2 to RX16-1 and RX16-2, respectively.

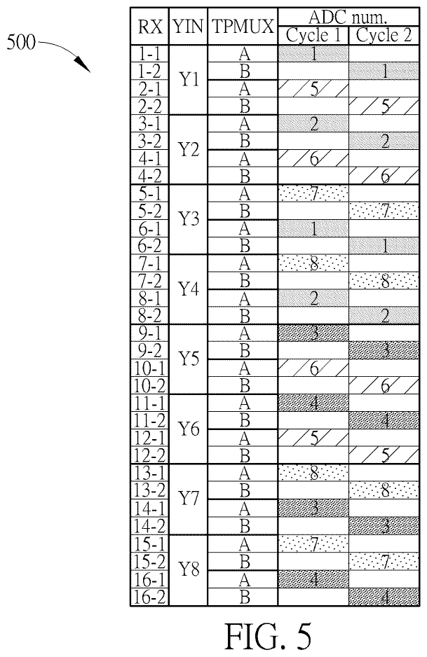

FIG. 5 is a schematic diagram of a predetermined mapping scheme 500 according to another embodiment of the present invention. The predetermined mapping scheme 500 includes a cyclic mapping of the plurality of touch line receivers RX1-1 to RX16-2 to the plurality of ADCs A1 to A8 via the plurality of MUXs M1 to M8 and the plurality of TPMUXs T1 to T16. In an embodiment, touch line receivers RX1 to RX16 are coupled to TPMUXs T1 to T16, respectively. In the first time cycle, the first receiver group of each TPMUX is enabled. For example, TPMUX T1 switches to the touch line receiver RX1-1, TPMUX T2 switches to the touch line receiver RX2-1, TPMUX T3 switches to the touch line receiver RX3-1, TPMUX T4 switches to the touch line receiver RX4-1, TPMUX T5 switches to the touch line receiver RX5-1, TPMUX T6 switches to the touch line receiver RX6-1, TPMUX T7 switches to the touch line receiver RX7-1, TPMUX T8 switches to the touch line receiver RX8-1, TPMUX T9 switches to the touch line receiver RX9-1, TPMUX T10 switches to the touch line receiver RX10-1, TPMUX T11 switches to the touch line receiver RX11-1, TPMUX T12 switches to the touch line receiver RX12-1, TPMUX T13 switches to the touch line receiver RX13-1, TPMUX T14 switches to the touch line receiver RX14-1, TPMUX T15 switches to the touch line receiver RX15-1, TPMUX T16 switches to the touch line receiver RX16-1. In the second time cycle, the second receiver group of each TPMUS is enabled. For example, TPMUX T1 switches to the touch line receiver RX1-2, TPMUX T2 switches to the touch line receiver RX2-2, TPMUX T3 switches to the touch line receiver RX3-2, TPMUX T4 switches to the touch line receiver RX4-2, TPMUX T5 switches to the touch line receiver RX5-2, TPMUX T6 switches to the touch line receiver RX6-2, TPMUX T7 switches to the touch line receiver RX7-2, TPMUX T8 switches to the touch line receiver RX8-2, TPMUX T9 switches to the touch line receiver RX9-2, TPMUX T10 switches to the touch line receiver RX10-2, TPMUX T11 switches to the touch line receiver RX11-2, TPMUX T12 switches to the touch line receiver RX12-2, TPMUX T13 switches to the touch line receiver RX13-2, TPMUX T14 switches to the touch line receiver RX14-2, TPMUX T15 switches to the touch line receiver RX15-2, TPMUX T16 switches to the touch line receiver RX16-2. In an embodiment, the first receiver group for the first time cycle and the second receiver group for the second time cycle are mutually exclusive.

In other words, in the sensing system 400, the division of the plurality of touch line receivers (RX1-1 to RX16-2) into at least a first receiver group and a second receiver group serves the purpose of time-division. The partitioning is implemented to facilitate the operation of these receiver groups in a time-division manner. That is, the sensing system 400 is configured to activate or enable the first receiver group for touch signal reception during the first time cycle, and subsequently activate or enable the second receiver group for touch signal reception during the second time cycle.

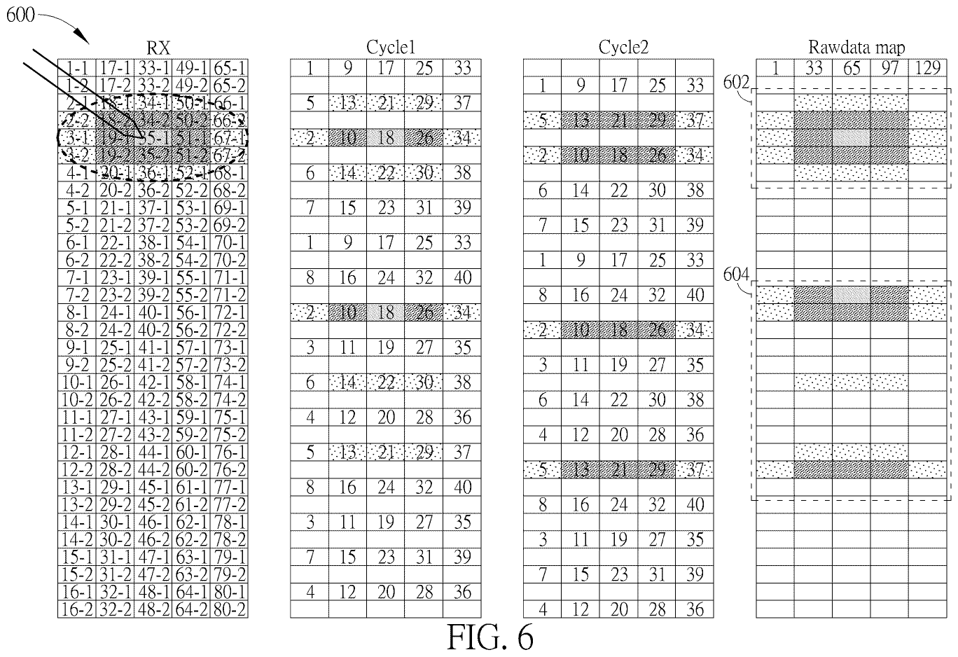

FIG. 6 is a schematic diagram of a sensing algorithm 600 according to another embodiment of the present invention. The sensing system in FIG. 6 includes 160 touch line receivers RX1-1 to RX80-2, 40 ADCs A1 to A40, 40 MUXs M1 to M40, 80 TPMUXs T1 to T80 and a controller coupled to the MUXs M1 to M40. In operation, when an input object makes contact with the touch screen proximate to a touch line receiver RX35-1, the touch line receiver RX35-1 detects a first touch signal. Concurrently, touch line receivers immediately surrounding the contact point, namely RX18-2, RX19-1, RX19-2, RX34-2, RX35-2, RX50-2, RX51-1, and RX51-2, detect second touch signals. Furthermore, touch line receivers located near the contact area, specifically touch line receivers RX2-2, RX3-1, RX3-2, RX18-1, RX20-1, RX34-1, RX36-1, RX50-1, RX52-1, RX66-2, RX67-1, and RX67-2, detect third touch signals. The signal strength hierarchy is such that the first touch signal possesses a greater magnitude than the second touch signals, and the second touch signals, in turn, possess a greater magnitude than the third touch signals.

This is due to the physical characteristics of the touch event (e.g., a finger or a stylus contacting the screen). When the input object contacts the touch screen, the resulting electrical effect (such as the voltage or energy distribution generated by capacitive coupling) is not confined to a single point. Instead, the electrical effect spreads spatially across the surface of the touch screen. Therefore, the highest signal strength will be at the touch line receiver closest to the actual contact point (in the embodiment, the touch line receiver RX35-1, receiving the first touch signal). As the distance from the contact point increases, the signal's influence gradually weakens, so the second touch signals received by the touch line receivers immediately surrounding the contact point (RX18-2, RX19-1, RX19-2, etc.) will be weaker, and the third touch signals received by the outer receivers (RX2-2, RX3-1, RX3-2, etc.) will have even weaker strength.

In an embodiment, the first touch signal is greater than a first threshold, the second touch signals are greater than a second threshold, and the third touch signals are greater than a third threshold.

In the first time cycle, the ADC A18 converts the first touch signal into a first digital signal, the ADCs A10 and A26 convert the second touch signals into the second digital signals, and the ADCs A2, A13, A14, A21, A22, A29, A30, and A34 convert the third touch signals into the third digital signals. In the second time cycle, the ADCs A13, A10, A21, A18, A29, and A26 convert the second touch signals into the second digital signals, and the ADCs A5, A2, A37, and A34 convert the third touch signals into the third digital signals. In an embodiment, the first digital signal is converted using the ADC A18, but ADC A18 can detect the signal from the touch line receiver RX35-1 or the touch line receiver RX40-1. This detection ambiguity arises because, as previously mentioned, each ADC is coupled to a corresponding MUX. The TPMUX sequentially enables different receiver groups during distinct time cycles. However, the touch line receivers within any single receiver group are active concurrently during that group's designated time cycle. As a result, the controller 402 cannot spatially distinguish between the individual touch line receivers belonging to the same active group based solely on the digital signal from that single time cycle. For example, after the controller 402 receives the digital signal from the first time cycle via a particular ADC (e.g., ADC18), the digital signal could correspond to input detected at either touch line receiver RX35-1 or touch line receiver RX40-1. Therefore, the controller 402 needs to combine the energy distribution information gathered across both the first time cycle and the second time cycle to determine the actual position of the touch event accurately.

Furthermore, the controller 402 is configured to analyze the processed digital signals representing the touch energy detected across the receiver array. Specifically, the controller 402 identifies a spatial pattern corresponding to the energy distribution associated with the input object's interaction with the touch screen. The determined spatial pattern is then compared by the controller 402 with a predefined effective characteristic shape. The predefined effective characteristic shape is stored or accessible by the controller 402 and represents a valid touch signature, defined by exhibiting a predetermined concentration of energy that is expected to be proximate to the actual position of the input object on the touch screen.

In the embodiment in FIG. 6, the position of the input object cannot be directly determined by considering only the first touch signal at the touch line receiver RX35-1 or the touch line receiver RX40-1. By comparing the characteristic shape combined by the first digital signal, the second digital signals, and the third digital signals, an effective characteristic shape 602 can be generated corresponding to the touch line receiver RX35-1. An invalid characteristic shape 604 can be generated corresponding to the touch line receiver RX40-1. Since the energy distribution within the invalid characteristic shape 604 is dispersed, the invalid characteristic shape 604 will be eliminated or discarded. Therefore, the effective characteristic shape 602 shows the correct position of the input object (stylus or finger) by comparing to the invalid characteristic shape 604.

In summary, the present invention discloses sensing systems 100 and 400 for identifying the correct position of the input object by comparing detected energy patterns against effective and invalid characteristic shapes. Moreover, the predetermined mapping scheme governing the connection of the touch line receivers to the plurality of ADCs enables reduced signal path lengths within the IC. The reduced signal path lengths and complexity lead to lower impedance, thereby enhancing the capability for accurately sampling energy from the input object, particularly a stylus or a finger.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing system for determining a position of an input object on a touch screen, the system comprising:
a plurality of touch line receivers, configured to receive a touch signal corresponding to the input object;
a plurality of multiplexers (MUXs), wherein each MUX is coupled to N touch line receivers based on a predetermined mapping scheme, N is an integer greater than one, and the N touch line receivers are partitioned into a first receiver group and a second receiver group;
a plurality of analog-to-digital converters (ADCs), wherein each ADC is coupled to a corresponding MUX and configured to convert the touch signal into a digital signal;
wherein the first receiver group is used for receiving the touch signal during a first time cycle, the second receiver group is used for receiving the touch signal during a second time cycle, and the position of the input object on the touch screen is determined based on at least the digital signal across the first time cycle and the second time cycle.

2. The sensing system of claim 1, wherein the input object is a pen or a finger.

3. The sensing system of claim 1, wherein a total number of the plurality of touch line receivers is M times a total number of the plurality of ADCs, wherein M is an integer greater than 1.

4. The sensing system of claim 1, wherein the predetermined mapping scheme comprises a cyclic mapping of the plurality of touch line receivers to the plurality of ADCs via the plurality of MUXs.

5. The sensing system of claim 1, further comprising:
a controller coupled to the plurality of ADCs and configured to identify a spatial pattern of an energy distribution associated with the input object by processing digital signals from the ADCs.

6. The sensing system of claim 5, wherein the controller compares the spatial pattern with a predefined effective characteristic shape, and the effective characteristic shape exhibits a predetermined concentration of energy proximate to the position of the input object.

7. The sensing system of claim 1, wherein the first receiver group for the first time cycle and the second receiver group for the second time cycle are mutually exclusive.

8. The sensing system of claim 1, further comprising:
a plurality of touch panel multiplexers (TPMUXs) integrated with the touch screen panel, wherein each TPMUX is coupled to K touch line receivers, K is a positive integer greater than one;
wherein the K touch line receivers are used for receiving K touch signals at different time slots, the K touch signals are sequentially received by a corresponding MUX.

9. The sensing system of claim 8, wherein the each TPMUX is configured to select a touch signal from the K touch signals so as to reduce integrated circuit (IC) pins of the plurality of touch line receivers.

10. The sensing system of claim 1, wherein the first time cycle and the second time cycle alternates within a touch sensing frame.
